(19) United States
(12) Patent Application Publication
(10) Pub. No.: US 2004/0034655 A1
(43) Pub. Date: Feb. 19, 2004

(54) Multimedia system and method

(76) Inventors: Kirk Steven Tecu, Greeley, CO (US); William Robert Haas, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/196,862

(22) Filed: Jul. 17, 2002

(51) Int. Cl. G06F 7/00

(52) U.S. Cl. 707/104.1

(57) ABSTRACT

A multimedia system comprises a database accessible by a processor and adapted to store at least one data stream having audio data. The system also comprises an encoder routine accessible by the processor and adapted to encode metadata at a plurality of predetermined intensity levels at a human-inaudible frequency and populate the audio data of the data stream with the encoded metadata.

### TECHNICAL FIELD OF THE INVENTION

The present invention relates generally to the field of audio and video data systems and, more particularly, to a multimedia system and method.

### BACKGROUND OF THE INVENTION

Data streams such as MPEG-compressed formats and other compressed or uncompressed formats may be used to hold video data in the form of images and/or audio data. Reserve fields may sometimes be used within the data stream to store various types of information. For example, reserve fields not defined by the MPEG specification may be used to hold various types of information in an MPEG data stream. However, information contained within these reserve fields may be overwritten or erased, either intentionally or accidentally. Thus, the information stored in the reserve fields of the data stream may be inadvertently removed or corrupted.

### SUMMARY OF THE INVENTION

In accordance with one embodiment of the present invention, a multimedia system comprises a database accessible by a processor and adapted to store at least one data stream having audio data. The system also comprises an encoder routine accessible by the processor and adapted to encode metadata at a plurality of predetermined intensity levels at a human-inaudible frequency and populate the audio data of the data stream with the encoded metadata.

In accordance with another embodiment of the present invention, a multimedia method comprises retrieving a data stream having audio data and encoding metadata at a plurality of predetermined intensity levels at a human-inaudible frequency. The method also comprises populating the audio data of the data stream with the encoded metadata.

### BRIEF DESCRIPTION OF THE DRAWINGS

For a more complete understanding of the present invention and the advantages thereof, reference is now made to the following descriptions taken in connection with the accompanying drawings in which:

FIG. 1 is a block diagram illustrating one embodiment of a multimedia system in accordance with the present invention;

FIG. 2 is a flow diagram illustrating one embodiment of a multimedia method in accordance with the present invention; and

FIG. 3 is a flow diagram illustrating another embodiment of a multimedia method in accordance with the present invention.

### DETAILED DESCRIPTION OF THE DRAWINGS

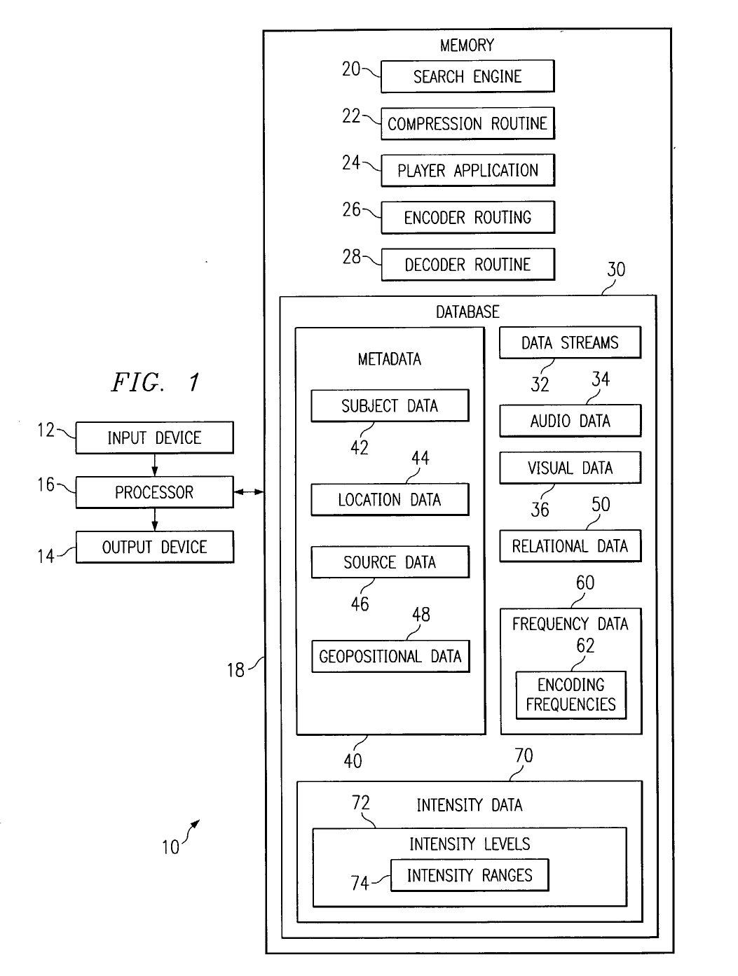

The preferred embodiments of the present invention and the advantages thereof are best understood by referring to FIGS. 1-3 of the drawings, like numerals being used for like and corresponding parts of the various drawings.

FIG. 1 is a diagram illustrating an embodiment of a multimedia system 10 in accordance with the present invention. Briefly, system 10 provides metadata storage within a data stream. For example, in accordance with one embodiment of the present invention, metadata is populated within an audio track of the data stream at a human inaudible or imperceptible frequency. The metadata may comprise information associated with the data stream, such as, but not limited to, a source of data stream, a subject corresponding to the data stream, or other attributes related or unrelated to the content of the data stream.

In the illustrated embodiment, system 10 compromises an input device 12, an output device 14, a processor 16, and a memory 18. Device 12 may comprise a keyboard, keypad, pointing device, such as a mouse or a track pad, a scanner, a camera, such as a camcorder or other audio/video recording device, or other type of device for inputting information into system 10. Output device 14 may comprise a monitor, display, amplifier, receiver, or other type of device for generating an output.

The present invention also encompasses computer software, hardware, or a combination of software and hardware that may be executed by processor 16. In the illustrated embodiment, memory 18 comprises a search engine 20, a compression routine 22, a player application 24, an encoder routine 26, and a decoder routine 28, any or all of which may comprise computer software, hardware, or a combination of software and hardware. In the embodiment of FIG. 1, search engine 20, compression routine 22, player application 24, encoder and decoder routines 26 and 28 are illustrated as being stored in memory 18, where they may be executed by processor 16. However, it should be understood that engine 20, application 24, and routines 22, 26 and 28 may be otherwise stored elsewhere, even remotely, as to be accessible by processor 16.

In the illustrated embodiment, memory 18 also comprises a database 30 having information associated with one or more data streams 32. Data steams 32 may comprise one or more compressed or uncompressed files of data containing audio data 34 and/or visual data 36. Data streams 32 may comprise data formatted and/or compressed corresponding with the MPEG specification such as, but not limited to, MPEG1, MPEG2, and MP3. However, it should also be understood that the format of data streams 32 may be otherwise configured. Additionally, as described above, data streams 32 may be stored, transmitted, or otherwise manipulated in a compressed or uncompressed format.

In the illustrated embodiment, database 30 also comprises metadata 40 having information associated with one or more data streams 32. For example, in the illustrated embodiment, metadata 40 comprises subject data 42, location data 44, source data 46, and geopositional data 48. Subject data 42 may comprise information associated with a subject of a particular data stream 32. The subject information may relate to a general topic corresponding to the particular data stream 32 or may relate one or more individuals appearing in or otherwise contained within the particular data stream 32. Location data 44 may comprise information associated with a site or location of a particular data stream 32, such as, but not limited to, a particular city, country, or other location. Source data 46 may comprise information associated with the source of a particular data stream 32. For example, various data streams 32 may be acquired from news services, electronic mail communications, various web pages, or other sources. Thus, source data 46 may comprise information associated with the particular source of the data stream 32. Geopositional data 48 may comprise information associated with an orientation or a viewing direction of visual data 36 corresponding to a particular data stream 32. For example, multiple camera angles may be used to record visual data 36 corresponding to a particular event or feature. Accordingly, geopositional data 48 may identify a particular camera angle corresponding to a particular data stream 32. It should also be understood, however, that other types of information may be included within metadata 40 to describe or otherwise identify a particular data stream 32.

Metadata 40 may also comprise other information that may be used in combination with or separate from information contained in data stream 32. For example, metadata 40 may comprise security information, decoding instructions, or other types of information. Thus, a variety of types of information may be encoded into audio data 34 in accordance with an embodiment of the present invention.

In the illustrated embodiment, database 30 also comprises relational data 50 having information relating metadata 40 to one or more particular data streams 32. For example, relational data 40 may comprise a table or other data structure relating subject data 42, location data 44, source data 46, and/or geopositional data 48 to one or more data streams 32.

In the embodiment illustrated in FIG. 1, database 30 also comprises frequency data 60 having information associated with encoding of metadata 40 within data streams 32. For example, in the illustrated embodiment, frequency data 60 comprises one or more encoding frequencies 62 at which metadata 40 is encoded. Generally, one or more human-inaudible or human-imperceptible frequencies 62 are selected for encoding metadata 40 such that the encoded metadata 40 does not detrimentally affect audio data 34 audible to human hearing. In the embodiment illustrated in FIG. 1, database 30 also comprises intensity data 70 having information associated with encoded metadata 40. For example, in the illustrated embodiment, intensity data 70 comprises signal amplitude or intensity levels 72 used to encode metadata 40 such that various intensity levels 72 may be used to designate a particular bit pattern of information. Additionally, various intensity ranges 74 may also be used to designate a particular bit pattern of information. For example, a particular range of signal level strengths may be used to identify a bit designation of “1” while another range of signal level strengths may be used to identify a bit designation of “0.”

In operation, compression routine 32 is used to compress data stream 32 into a desired format. For example, data stream 32 may comprise an MPEG data file or other format of data file in a compressed format. Correspondingly, player application 24 may be used to decompress data streams 32 and generate an output of visual data 36 and/or audio data 34 of the particular data stream 32 to output device 14.

Encoder routine 26 encodes metadata 40 at one or more desired frequencies 62 and populates audio data 34 with the encoded metadata 40. For example, encoder routine 26 may encode metadata 40 at a frequency 62 generally inaudible or imperceptible to human hearing such that the encoded metadata 40 does not detrimentally affect audio data 34 audible to human hearing. For example, metadata 40 may be encoded at a frequency 62 of approximately 20 kHz or greater, thereby rendering the encoded metadata 40 inaudible to human hearing. If data stream 32 is to be compressed, the encoded metadata 40 may be inserted into audio data 34 either before or after compression, thereby providing additional functionality and versatility to system 10. Thus, according to one embodiment of the present invention, the encoded metadata 40 becomes an integral part of a particular data stream 32 such that the encoded metadata 40 cannot be easily erased or removed from the particular data stream 32.

Decoder routine 28 decodes the encoded metadata 40 to determine the unencoded content of the metadata 40. For example, during playback of a particular data stream 32 using player application 24, decoder routine 28 may decode the encoded metadata 40 to determine the unencoded content of metadata 40. Decoder routine 28 may also be configured to operate independently of player application 24 to decode metadata 40 independently of a playback operation. For example, the encoded metadata 40 may be inserted into a particular location of the data stream 32, such as a beginning portion of the data stream 32, such that decoder routine 28 may access a portion of data stream 32 to quickly and efficiently decode the metadata 40.

Processor 16 also generates relational data 50 corresponding to the encoded metadata 40 such that metadata 40 may be correlated to particular data streams 32. Relational data 50 may be generated before, during, or after encoding of metadata 40 or insertion of encoded metadata 40 into a particular data stream 32. For example, relational data 50 may be generated after decoding of metadata 40 by decoder routine 28, or relational data 50 may be generated upon encoding or insertion of metadata 40 into a particular data stream 32. Thus, in operation, search engine 20 may be used to quickly and efficiently locate a particular data stream 32 using search parameters corresponding to metadata 40.

In accordance with one embodiment of the present invention, encoder routine 26 may encode metadata 40 by generating a bit pattern at one or more desired inaudible frequencies 62. Encoder routine 26 may encode metadata 40 by generating various amplitude values or signal intensities levels 72 at the desired frequency 62 to represent a bit of data corresponding to metadata 40. For example, predetermined ranges 74 of signal intensities 72 at one or more desired frequencies 62 may be assigned a particular bit designation, such as either a “1” or “0.” Thus, for example, a relatively low intensity level 72 or a relatively high intensity level 72 may be used to represent a bit of data corresponding to metadata 40. Therefore, populating a range of intensity values at the desired frequencies 62 represents a bit pattern for storage of metadata 40 within the audio data 34. The particular data streams 32 may then be stored, transferred, or otherwise manipulated without alteration of the encoded metadata 40.

In operation, because data streams 32 are generally not lossless, metadata 40 encoded by routine 26 to represent a particular intensity level 72 at a desired frequency 62 may not retain that same intensity level 72 when later played using player application 24 or decoded using decoder routine 28. Thus, in some embodiments, decoder routine 28 may be configured to decode metadata 40 by designating various ranges 74 of intensity levels 72 as particular bit representations. Bit representations within a particular intensity range 74, such as a very small intensity level range 74, may be designated as a “0,” and bit representations with another intensity level range 74, such as a very high or near a maximum intensity level 72, may be designated as a “1.” Additionally, a portion of data stream 32 may also designate to decoder routine 28 which intensity ranges 74 correspond to particular bit designations.

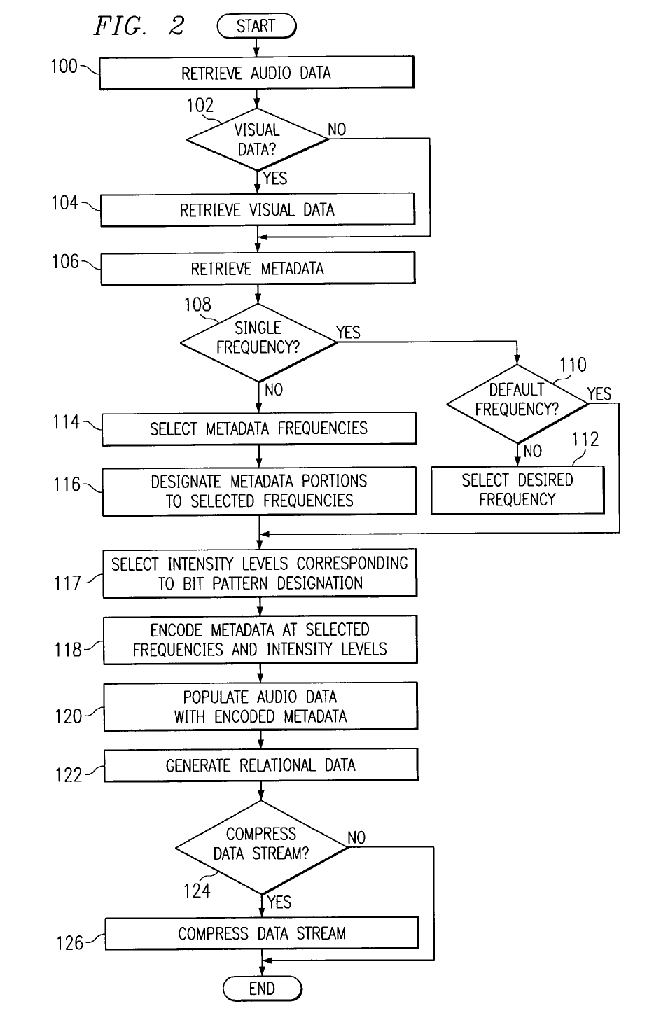

FIG. 2 is a flow diagram illustrating an embodiment of a multimedia method in accordance with the present invention. The method begins at step 100, where processor 16 retrieves audio data 34. At decisional step 102, a determination is made whether a particular data stream 32 includes visual data 36. If the particular data stream 32 includes visual data 36, the method proceeds to step 104, where a processor 16 retrieves the corresponding visual data 36. If the particular data stream 32 does not include visual data 36, the method proceeds from step 102 to step 106.

At step 106, processor 16 retrieves metadata 40 to be included within the data stream 32. For example, a user of system 10 may input various types of metadata 40, such as subject data 42, location data 44, source data 46, and/or geopositional data 48 into database 30 using input device 12. Various types of metadata 40 may then be selected to be combined with the particular data stream 32.

At decisional step 108, a determination is made whether metadata 40 will be encoded at a single frequency 62. If metadata 40 will be encoded at a single frequency 62, the method proceeds from step 108 to decisional step 110, where a determination is made whether a default frequency 62 shall be used for encoding metadata 40. If a default frequency 62 will not be used to encode metadata 40, the method proceeds from step 110 to step 112, where a user of system 10 may select a desired frequency 62 for encoding metadata 40. If a default frequency 62 shall be used to encode metadata 40, the method proceeds from step 110 to step 118. When more than a single frequency 62 shall be used to encode metadata 40, the method proceeds from step 108 to step 114.

At step 114, encoder routine 26 selects the frequencies 62 for encoding metadata 40. For example, encoder routine 26 may access frequency data 60 to acquire one or more default frequencies 62 for encoding metadata 40. Frequency data 60 may also comprise one or more frequencies 62 selected by a user of system 10 for encoding metadata 40.

At step 116, encoder routine 26 designates metadata 40 to be encoded at each of the selected frequencies 62. For example, each type of metadata 40 to be included in the particular data stream 32 may be encoded at each of a plurality of designated frequencies 62. Thus, for example, subject data 42 may be encoded at a particular frequency 62 and location data 44 may be encoded at another frequency 62. At step 117, encoder routine 26 selects the intensity levels 72 for encoding metadata 40 corresponding to a particular bit pattern. At step 118, encoder routine 26 encodes metadata 40 at the selected frequencies 62 and intensity levels 72.

At step 120, encoder routine 26 populates audio data 34 with the encoded metadata 40. As described above, encoder routine 26 may also populate initial portions of audio data 34 with information identifying the encoding frequencies 62, intensity levels 72, and/or other information associated with decoding the metadata 40. At step 122, relational data 50 is generated corresponding to metadata 40. In this embodiment, relational data 50 is generated during population and/or encoding of metadata 40. However, as described above, relational data 50 may also be generated in response to decoding metadata 40. Thus, a user of system receiving a data stream 32 having encoded metadata 40 may use system 10 to generate relational data 50 which may be used later to search for the particular data stream 32 using search engine 20.

At decisional step 124, a decision is made whether the particular data stream 32 will be compressed. If the particular data stream 32 will be compressed, the method proceeds from a step 124 to step 126, where compression routine 22 compresses the data stream 32 according to a desired format. If no compression of the data stream 32 is desired, the method ends.

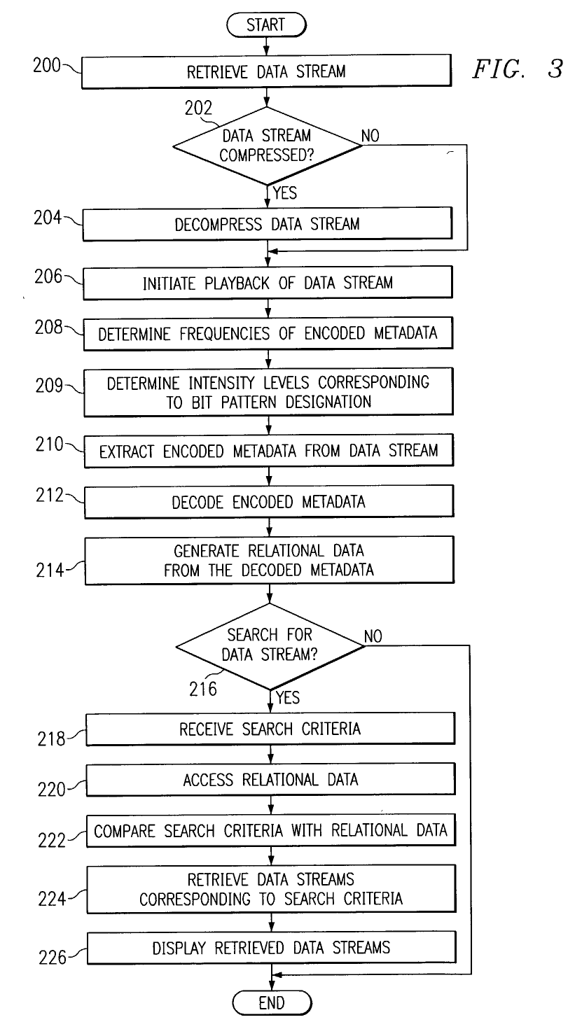

FIG. 3 is a flow diagram illustrating another embodiment of a multimedia method in accordance with the present invention. In this embodiment, the method begins at step 200, where processor 16 retrieves a particular data stream 32. At decisional step 202, a determination is made whether the particular data stream 32 is in a compressed format. If the data stream 32 is in a compressed format, the method proceeds from step 202 to step 204, where player application 24 decompresses the particular data stream 32. If the data stream 32 is not in a compressed format, the method proceeds from step 202 to step 206.

At step 206, player application 24 initiates playback of the desired data stream 32. At step 208, decoder routine 28 identifies and determines the frequencies 62 of the encoded metadata 40. For example, as described above, initial portions of audio data 34 may include information identifying the encoding frequencies 62 of metadata 40. These decoding instructions may be encoded at a predetermined frequency 62. Thus, the decoding instructions may be encoded at a frequency 62 different than the frequency 62 of the encoded metadata 40. As described above, decoder routine 28 may also decode metadata 40 independently of playback of the data stream 32 by player application 24. At step 209, decoder routine 28 determines intensity data 70 associated with generating a bit pattern corresponding to metadata 40. For example, decoder routine 28 determines the intensity levels 72 and/or intensity ranges 74 of the encoded metadata 40 to accommodate generating a bit pattern corresponding to the metadata 40.

At step 210, decoder routine 28 extracts the encoded metadata 40 from data stream 32. At step 211, decoder routine 28 decodes the encoded metadata 40 using intensity data 70 to generate a bit pattern corresponding to metadata 40. At step 214, processor 16 generates relational data 50 corresponding to the decoded metadata 40.

At decisional step 216, a determination whether a search for a particular data stream 32 is desired. If a search for a particular data stream 32 is not desired, the method ends. If a search for a particular data stream 32 is desired, the method proceeds from step 216 to step 218, where processor 16 receives one or more search criteria from a user of system 10. For example, the search criteria may include information associated with a subject, location, source, or other information relating to one or more data streams 32.

At step 220, search engine 20 accesses relational data 50. At step 222, search engine 20 compares the received search criteria with relational data 50. At step 224, search engine 20 retrieves one or more data streams 32 corresponding to the search criteria. At step 226, search engine 20 displays the retrieved data streams 32 corresponding to the desired search criteria.

It should be understood that in the described methods, certain steps may be omitted, accomplished in a sequence different from that depicted in FIGS. 2 and 3, or performed simultaneously. Also, it should be understood that the methods depicted in FIGS. 2 and 3 may be altered to encompass any of the other features or aspects of the invention as described elsewhere in the specification.

What is claimed is:

1. A multimedia system, comprising:
a database accessible by a processor and adapted to store at least one data stream having audio data; and
an encoder routine accessible by the processor and adapted to encode metadata at a plurality of predetermined intensity levels at a human-inaudible frequency and populate the audio data of the data stream with the encoded metadata.

2. The system of claim 1, wherein the frequency comprises a frequency greater than 20 KHz.

3. The system of claim 1, wherein the metadata comprises information corresponding to the data stream.

4. The system of claim 1, further comprising a decoder routine accessible by the processor and adapted to decode the encoded metadata.

5. The system of claim 1, further comprising a database having relational data relating the metadata to the data stream.

6. The system of claim 1, further comprising a search engine accessible by the processor and adapted to locate the data stream within the database using the metadata.

7. The system of claim 1, wherein the metadata comprises information associated with a subject of the data stream.

8. The system of claim 1, wherein the metadata comprises geopositional data.

9. The system of claim 1, wherein the metadata comprises a source of the data stream.

10. The system of claim 1, further comprising a compression routine accessible by the processor and adapted to compress the data stream.

11. The system of claim 1, wherein the plurality of predetermined intensity levels comprises a plurality of predetermined intensity level ranges.

12. The system of claim 1, wherein the plurality of predetermined intensity levels corresponds to a predetermined bit pattern for the metadata.

13. A multimedia method, comprising:
retrieving a data stream having audio data;
encoding metadata at a plurality of predetermined intensity levels at a human-inaudible frequency; and
populating the audio data of the data stream with the encoded metadata.

14. The method of claim 13, wherein encoding comprises encoding the metadata at a frequency greater than 20 Khz.

15. The method of claim 13, further comprising generating relational data relating the metadata to the data stream.

16. The method of claim 13, further comprising decoding the metadata.

17. The method of claim 13, further comprising searching for the data stream using the metadata.

18. The method of claim 13, wherein encoding the metadata comprises encoding information associated with a source of the data stream.

19. The method of claim 13, wherein encoding the metadata comprises encoding geopositional data.

20. The method of claim 13, wherein encoding the metadata comprises encoding information associated with a subject of the data stream.

21. The method of claim 13, wherein encoding the metadata comprises encoding the metadata at a plurality of predetermined intensity level ranges.

22. A multimedia system, comprising:
a database accessible by a processor and adapted to store at least one data stream having audio data; and
a decoder routine accessible by the processor and adapted to decode metadata populated within the audio data, the metadata encoded at a plurality of predetermined intensity levels at a human-inaudible frequency.

23. The system of claim 22, wherein the frequency comprises a frequency greater than 20 KHz.

24. The system of claim 22, wherein the metadata comprises information associated with a source of the data stream.

25. The system of claim 22, wherein the metadata comprises information associated with a subject of the data stream.

26. The system of claim 22, wherein the database comprises relational data relating the metadata to the data stream.

27. The system of claim 22, further comprising a search engine adapted to locate the data stream within the database using the metadata.

28. The system of claim 22, wherein the metadata comprises geopositional data.

29. The system of claim 22, wherein the frequency comprises a range of human-inaudible frequencies.

30. The system of claim 22, wherein the plurality of predetermined intensity levels comprises a plurality of predetermined intensity level ranges.

31. A multimedia system, comprising:
means for storing at least one data stream having audio data;
means for encoding metadata at a plurality of predetermined intensity levels at a human-inaudible frequency; and
means for populating the encoded metadata within the audio data of the data stream.

32. The system of claim 31, further comprising means for relating the metadata to the data stream.

33. The system of claim 31, further comprising means for searching a database for the data stream using the metadata.

34. The system of claim 31, wherein the means for encoding comprises means for encoding the metadata at a frequency greater than 20 KHz.

35. The system of claim 31, wherein the metadata comprises information associated with a source of the data stream.

36. The system of claim 31, wherein the metadata comprises information associated with a subject of the data stream.

37. The system of claim 31, wherein the metadata comprises geopositional data.

38. The system of claim 31, further comprising means for compressing the data stream.

39. The system of claim 31, further comprising means for decoding the metadata.

40. The system of claim 31, wherein the means for encoding metadata comprises means for encoding metadata at a plurality of predetermined intensity level ranges.
